(19) United States
(12) Patent Application Publication
(10) Pub. No.: US 2006/0188775 A1
(43) Pub. Date: Aug. 24, 2006

(54) Oxidation resistant electrode for fuel cell

(76) Inventors: Andrew M. Mance, Royal Oak, MI (US); Mei Cai, Bloomfield Hills, MI (US); Cecilia Carriquiry, Boston, MA (US); Martin S. Ruthkosky, Sterling Heights, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/354,213

(22) Filed: Feb. 14, 2006

Related U.S. Application Data
(60) Provisional application No. 60/654,307, filed on Feb. 18, 2005.

(51) Int. Cl. H01M 4/96; H01M 8/10; H01M 4/88

(52) U.S. Cl. 429/44; 429/30; 502/101

(57) ABSTRACT

An oxygen reducing electrode for a fuel cell comprises carbon particles as support for catalyst particles. The carbon particles are coated with smaller particles of a metal oxide and/or metal phosphate (for example, TiO₂ particles) to impede destructive oxidation (corrosion) of the carbon particles while permitting suitable electrical conductivity between the carbon particles. The catalyst is carried on the smaller particle-coated carbon particles. Titanium dioxide particles can be dispersed on carbon particles suspended in a liquid medium by ultrasonic decomposition of a suitable titanium precursor compound.

### CROSS-REFERENCE TO RELATED APPLICATION

This application claims the benefit of U.S. Provisional Application 60/654307, filed Feb. 18, 2005 and titled “Method for Preventing Oxidation of a Carbon Surface and Structure Thereof.” The disclosure of that provisional application is incorporated herein by reference.

### TECHNICAL FIELD

This invention relates to a method for mitigating oxidation of a carbon surface with a particulate metal oxide oxidation barrier, especially when the carbon supports a catalyst in an oxidizing environment. In a more specific embodiment, this invention relates to coating carbon particles (intended as a support for catalyst particles) with smaller particles of a metal oxide, such as titanium dioxide, to inhibit oxidation of the carbon while retaining suitable electrical conductivity between carbon particles. Thus, when catalyst particles are applied to the carbon/metal oxide particle combination the resulting supported catalyst is resistant to destructive oxidation and is suitably electrically conductive for use in a device such as a fuel cell.

### BACKGROUND OF THE INVENTION

Polymer electrolyte membrane (PEM) fuel cells are efficient and non-polluting electrical power generators based on two electrochemical reactions: the oxidation of hydrogen (anode side of the cell membrane) and the reduction of oxygen (cathode side). Suitable pendent groups (sometimes sulfonic acid groups) on the polymer molecules of the electrolyte membrane serve in conduction of protons from anode to cathode, and electrons flow through an external resistive load to and from the electrodes.

PEM fuel cells operate at temperatures (for example, 80° C.) at which electrode catalysts are required to generate useful currents. Because of the acidic environment inside fuel cells platinum and its alloys have been used in full-size applications. To achieve acceptable platinum loading, nanometer size crystallites of the metal or alloy are supported on high surface area carbon particles, which normally would be expected to provide suitable electrical conductivity and good corrosion resistance. However, in the presence of an acidic environment, oxygen at the cathode, and an electric field during PEM operation, maintaining the overall stability of such a supported catalyst remains a challenge in commercializing PEM fuel cells.

During the operation of a PEM fuel cell, carbon particles in the cathode can react with transient oxygenated radicals, such as HO— and HOO—, generated by the catalyst and/or water to form oxygen functionalities (e.g., lactones, ketones, alcohols, carboxylate groups, etc.), which then proceed to form gaseous products, CO and CO₂. In this degradation process, the weight of carbon in the catalyst layer will gradually decrease over time. As this loss of carbon support occurs, nanometer-sized Pt particles may agglomerate to form larger particles leading to the loss of active Pt surface area and a drop in catalytic activity. Alternatively, the Pt may simply migrate into other parts of the cell. The deterioration of PEM fuel cell catalyst performance is a significant concern that must be addressed before practical automotive applications can be achieved.

### SUMMARY OF THE INVENTION

This invention relates to carbon support structures intended for operation in an oxidizing environment and is intended to provide suitable electron conductivity within the structures, or to and from them. Surfaces of the carbon are coated with particles of a suitable metal oxide material so as to mitigate oxidation of the carbon surface(s) while retaining suitable electrical conductivity to the surface(s). The invention is particularly applicable to high surface area, carbon catalyst support particles in a fuel cell electrode structure.

In accordance with one embodiment, this invention provides a method for minimizing the oxidation of carbon by depositing a suitable coating of metal oxide particles on the exposed surface(s) of the carbon. By way of example, the carbon structure(s) may be in the form of nanometer-size to micrometer-size carbon particles, including short carbon fibers, having relatively large specific surface areas (100 square meters or higher per gram), and a coating of nanometer size titania particles may be deposited on surfaces of such carbon particles

This invention has particular utility in addressing the above-described electrode oxidation problem associated with fuel cell (FC) durability. The purpose of the protective metal oxide coating is to reduce exposure of the carbon to oxygen-containing species or to otherwise slow carbon oxidation so that oxidation is no longer a significant problem in FC operation. Carbon particles having high specific surface area provide support structures for fuel cell catalyst particles. The approach of this invention is to coat the carbon with an oxidation-resistant or oxidation-impeding material that retains suitable electrical conductivity in the particulate carbon support-oxidation barrier-catalyst combination.

It will be appreciated that electrically semi-conductive barriers comprised of various materials such as metal oxides or electrically conductive or semi-conductive polymeric materials may be applied to the carbon surface to retard or impede the oxidation process. For example, several different metal oxides may be suitable for this purpose, such as oxides of chromium, cobalt, copper, indium, iron, molybdenum, nickel, tin, titanium, tungsten, vanadium, or zirconium. Moreover, suitable metal phosphates, phosphate-oxides and mixed oxides of more than one metal may be selected as oxidation barrier materials for carbon surfaces to be exposed to oxidation.

An ideal electrocatalyst support should show a suitable combination of electron conductivity, chemical stability (especially oxidation resistance), and surface area for carrying catalyst particles. A practice of the invention will be illustrated in terms of the use of a preferred metal oxide coating for carbon particles. Titania, TiO₂, is a widely used semiconductor material, and it can be modified to show increased electron conductivity after doping and/or reducing treatments. The most preferred crystalline form of titania to be used for the coating appears to be the rutile crystalline phase due to its contribution to the oxygen reduction reactivity of a supported catalyst structure in a catalyzed electrode. It is also mechanically and chemically stable/fairly inert within the electrolyte in the cell, both while current is being passed and while the cell is on open circuit. The titanium dioxide may also be doped with organic or inorganic substances to improve properties. For example, TiO₂ may become more electrically conductive if doped with another metal ion, such as niobium, or organic materials such as triphenyl amine.

There is a method aspect of this invention by which a particulate oxidation barrier layer is deposited on the surface(s) of the carbon. In accordance with a preferred embodiment, this method will be illustrated in the depositing of nanometer-size titanium dioxide particles on larger, high specific surface area carbon particles intended as support structures for platinum particles or other catalyst particles. The carbon particles are suspended in a liquid medium containing a dissolved titanium precursor compound (for example, titanium tetrachloride or titanium tetraisopropoxide). The acidity of the solution is adjusted to promote the precipitation of the precursor compound as the liquid suspension is subjected to ultrasonic vibrations. These conditions promote the deposition of very small titanium dioxide particles on the carbon particles. Platinum particles or other suitable catalyst particles are then deposited on the TiO₂ coated carbon particles, and the supported platinum catalyst is formed into an electrode layer on the polymer electrolyte membrane of each cell of a fuel cell stack.

Thus, this invention advantageously provides a potential method to reduce the carbon corrosion rate under fuel cell operating conditions while desirable intrinsic properties of carbon materials are retained. In addition to fuel cell applications for the coating as described above, there are other carbon usages for which minimizing the oxidation rate of carbon is desirable.

### BRIEF DESCRIPTION OF THE DRAWINGS

FIG. 1 is a schematic view of a combination of solid polymer membrane electrolyte and electrode assembly (MEA) for use in each cell of an assembled hydrogen-oxygen consuming fuel cell stack.

FIG. 2 is an enlarged fragmentary cross-section of the MEA of FIG. 1.

FIGS. 3A-3C are transmission electron microscope (TEM) images. FIG. 3A is a TEM of blank Vulcan Carbon XC-72 carbon particles. FIG. 3B is a TEM of anatase phase titanium oxide particles coated on Vulcan Carbon XC-72 particles, TiO₂/C. FIG. 3C is a TEM of rutile phase titanium oxide particles coated on Vulcan carbon XC-72 particles, TiO₂/C.

FIG. 4 is a graph of current (mA) vs. electrical potential (V) response for a stationary thin disc electrode of platinum catalyst particles on support particles of rutile phase TiO₂ on carbon (38 weight % Pt). The electrode is placed in an electrolytic cell with a 0. IM HClO₄ electrolyte (at 25° C. and under air at one atmosphere), and with a normal hydrogen reference electrode (NHE). The graph presents the measured cell current in mA as the electrical potential between the electrodes is cycled once from 0 V to 1.2 V and back to zero volts. HAD area is determined from this data.

FIG. 5 is a graph of current (mA) vs. electrical potential (V) response for a thin disc electrode of platinum catalyst particles on support particles of rutile phase TiO₂ on carbon (38 weight %). The thin disc electrode is placed in an electrolytic cell with a 0. 1M HClO₄ electrolyte (at 60° C. and under oxygen at one atmosphere), and with a normal hydrogen reference electrode. The thin disc electrode is rotated at 1,600 rpm. The graph presents the measured cell current in mA as the electrical potential between the electrodes is cycled once from zero volts to about 1 V and back to zero volts. The dashed line curve is for a voltage change scan rate of 5 mV/s and the solid line curve is for a voltage scan rate of 20 mV/s. Oxygen reduction reactivity (ORR) is determined from this data.

FIG. 6 is a graph of current (mA) vs. electrical potential (V) response for a stationary thin disc electrode of platinum catalyst particles on support particles of anatase phase TiO₂ on carbon (30.9 weight % Pt). The electrode is placed in an electrolytic cell with a 0.1M HClO₄ electrolyte (at 25° C. and under air at one atmosphere), and with a normal hydrogen reference electrode (NHE). The graph presents the measured cell current in niA as the electrical potential between the electrodes is cycled once from zero volts to 1.2 V and back to zero. HAD area is determined from this data.

FIG. 7 is a graph of current (mA) vs. electrical potential (V) response for a thin disc electrode of platinum catalyst particles on support particles of anatase phase TiO₂ on carbon (30.9 weight %). The thin disc electrode is placed in an electrolytic cell with a 0.1M HClO₄ electrolyte (at 60° C. and under oxygen at one atmosphere), and with a normal hydrogen reference electrode. The thin disc electrode is rotated at 1,600 rpm. The graph presents the measured cell current in mA as the electrical potential between the electrodes is cycled once from zero volts to about 1 V and back to zero. The dashed line curve is for a voltage change scan rate of 5 mV/s and the solid line curve is for a voltage scan rate of 20 mV/s. Oxygen reduction reactivity (ORR) is determined from this data.

### DESCRIPTION OF PREFERRED EMBODIMENTS

Many United States patents assigned to the assignee of this invention describe electrochemical fuel cell assemblies having an assembly of a solid polymer electrolyte membrane and electrode assembly. For example, FIGS. 1-4 of U.S. Pat. No.6,277,513 include such a description, and the specification and drawings of that patent are incorporated into this specification by reference.

FIG. 1 of this application illustrates a membrane electrode assembly 10 which is a part of the electrochemical cell illustrated in FIG. 1 of the '513 patent. Referring to FIG. 1 of this specification, membrane electrode assembly 10 includes anode 12 and cathode 14. In a hydrogen/oxygen (air) fuel cell, for example, hydrogen is oxidized to H⁺ (protons) at the anode 12 and oxygen is reduced to water at the cathode 14.

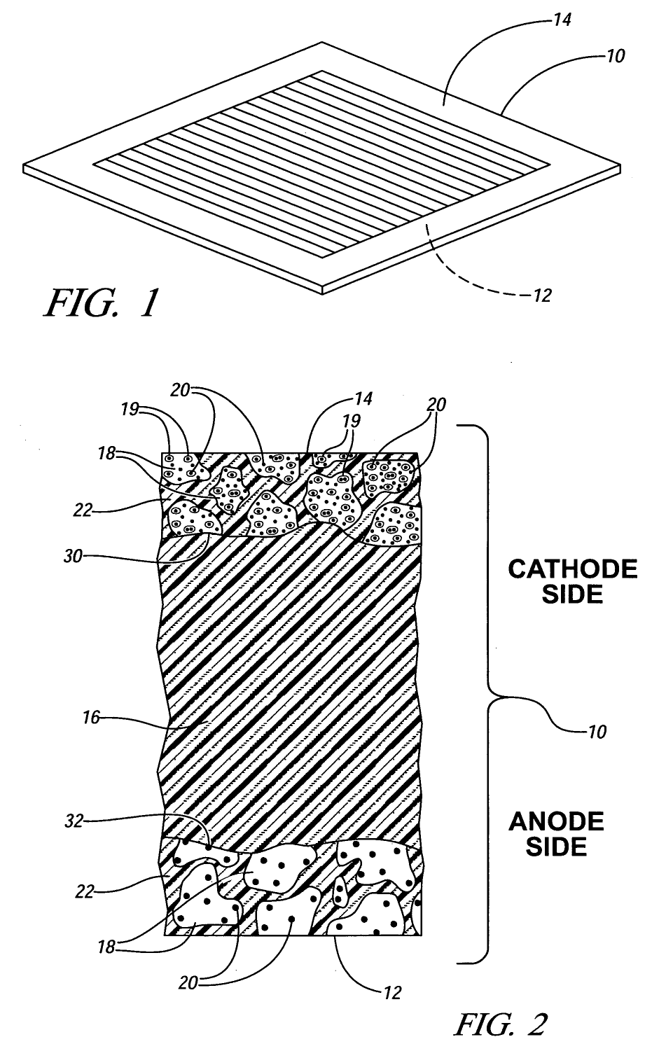

FIG. 2 provides an enlarged, fragmentary, cross-sectional schematic view of a membrane electrode assembly 10 similar to that shown in FIG. 1. In FIG. 2, anode 12 and cathode 14 are applied to opposite sides (sides 32, 30 respectively) of a proton exchange membrane 16. PEM 16 is suitably a membrane made of a perfluorinated ionomer such as Dupont's Nafion. The ionomer molecules of the membrane carry pendant ionizable groups (e.g. sulfonate groups) for transport of protons through the membrane from the anode 12 applied to the bottom surface 32 of the membrane 16 to the cathode 14, which is applied to the top surface 30 of the membrane 16. In an exemplary cell, the polymer electrolyte membrane may have dimensions of 100 mm by 100 mm by 0.05 mm. As will be described, the anode 12 and cathode 14 are both thin, porous electrode layers prepared from inks and applied either directly to the opposite surfaces 30, 32 of the PEM 16 through decals, or applied on a (carbon sheet) current collector.

In accordance with a preferred embodiment of this invention, cathode 14 suitably includes carbon catalyst support particles 18 carrying a coating of smaller particles 19 of oxidation barrier material. Particles 20 of a reduction catalyst for oxygen, such as platinum particles, are deposited on both the carbon catalyst support particles 18 and smaller oxidation barrier particles 19. In accordance with this invention, carbon catalyst support particles 18 have a high specific surface area and they are coated with smaller oxidation barrier material particles 19 of a metal oxide. Titanium dioxide particles are suitable and preferred as oxidation barrier particles 19 coated on the carbon support particles 18. Titanium oxide particles are semi-conductors and may be doped with a material that increases their electrical conductivity. In a specific illustrative example the carbon particles have an average nominal diameter or largest dimension of about fifty nanometers and the titanium dioxide particles are smaller with average diameters of about ten nanometers. As illustrated in FIG. 2, the very small catalyst particles 20 may be deposited on the surfaces of either or both carbon support particles 18 and metal oxide oxidation barrier particles 19. Thus, oxidation barrier particles 19 may also carry or support catalyst particles 20. Anode 12 may not require oxidation barrier particles and may suitably comprise carbon particles 18 with platinum particles 20.

The carbon support particles 18 (carrying oxidation barrier particles 19 and catalyst particles 20) for cathode 14 are embedded in a suitable conductive matrix material 22. In this embodiment, the matrix material 22 is suitably a proton conductive, perfluorinated ionomer material like the polymer electrolyte membrane 16 material. The matrix material may also contain an electron conducting material. A mixture of the platinum particle 20-bearing catalyst support particles 18 and oxidation barrier particles 19 with particles of the matrix material 22 is suspended in a suitable volatile liquid vehicle and applied to surface 30 of proton exchange membrane 16. The vehicle is removed by vaporization and the dried cathode 14 material further pressed and baked into surface 30 of PEM 16 to form cathode 16.

A preferred embodiment of carbon support particles with their oxidation-barrier coating is illustrated by the following experiments and analysis.

### EXPERIMENTAL

Synthesis of anatase TiO₂/C and rutile TiO₂/C

In this synthesis ultrasonic vibrational energy was applied to a dispersion in water of particles of a commercial high surface area carbon catalyst support material. Particles of titanium dioxide were deposited on the carbon particles by decomposition of titanium precursor compounds dissolved in the water. As described below different crystalline forms of titania (anatase and rutile) were deposited on the carbon particles depending upon the specific titanium precursor compound.

A fixed amount (1.0 g) of Vulcan Carbon XC-72 was put into a sonic reactor cell, and 90 mL deionized water was added and sonicated by employing a direct immersion titanium horn (Sonics and Materials, VC-600, 20 kHz, 100 W cm⁻²) for 15 min. At this stage 10 mL of the precursor (tetraisopropyltitanate (TPT) or titanium tetrachloride (TTC) from Aldrich Chemical Company) was injected into the sonication cell at ambient temperature. The sonication was conducted without cooling so that a temperature of 353 K was reached at the end of the reaction. The precipitates were separated by centrifugation and washed twice with deionized water followed by subsequent washings with ethanol. The product was further dried under vacuum overnight. It was found that under these reaction conditions the TPT precursor resulted in the deposit of anatase TiO₂ particles on the carbon particles and the use of the TTC precursor yielded rutile TiO₂ particles deposited on the carbon particles. Further synthesis conditions and product characteristics for anatase TiO₂/C and rutile TiO₂/C are summarized in Table 1.

TABLE 1
Sample Preparation Conditions

| | | | | TiO₂ | |
|---|---|---|---|---|---|
| | | Synthesis | TiO₂ | Particle | |
| Sample | Precursor | Conditions^{a} | Phase | Size^{b} | S_{BET} |
| A | TPT | Hydrolyzed in | Anatase | 6.7 nm | 217 m²g⁻¹ |
| | | water, sonicated | | | |
| | | for 3 h. | | | |
| B | TTC | Hydrolyzed in | Rutile | 14.4 nm | 175 m²g⁻¹ |
| | | water, sonicated | | | |
| | | for 3 h | | | |

^{a}Sonication was carried out under atmospheric pressure without cooling if no other conditions are specified.
^{b}Average particle size was estimated from PXRD line-broadening employing the Scherrer formula.

Physical Characterization

XRD patterns of the putative titania-on-carbon powder samples were recorded using Bruker D8 diffractometer, with Cu Ka radiation. Nitrogen adsorption-desorption isotherms were obtained with a Micromeritics instrument (Gemini 2375) for analysis of BET (Brunauer-Emmett-Teller) surface area and pore size distribution. Each sample was degassed at 150° C. prior to adsorption studies for at least 5 h until a pressure of 10⁻⁵ Pa was attained. The elemental analysis of the TiO₂ coatings on carbon was conducted with an X-ray photoelectron spectroscopy (XPS) method (Perkin-Elmer PHI5000C ESCA System). The morphologies of the TiO₂ coatings were studied by a scanning electron microscope (SEM) coupled with energy dispersive X-ray analysis (EDX). Transmission electron microscopy (TEM) studies were carried out on a JEOIL 2000 electron microscope. Samples for the TEM measurement were obtained by placing a drop of suspension from the as-sonicated reaction product in ethanol onto a carbon coated copper grid, followed by air drying to remove the solvent. The particle size distribution was determined by counting more than 300 particles from TEM pictures.

Resistivity Measurement

The electrical resistivity of titania coated carbon black was measured with a Model LR-700 AC Resistance Bridge made by Linear Research Inc.. This apparatus is capable of handling small sample sizes (0.1-0.5 g range) and uses the four-point probe method to measure the electrical conductivity of powders with controlled porosity. After applying 200 - 220 lb clamping force to the powdered materials, an electrical current (i) was passed through the compressed materials and the resistance was calculated through the voltage drop between the two side probes.

Catalyst Synthesis

Pt was deposited on anatase and rutile TiO₂ coated carbon blacks (substrates) using an aqueous solution of diamineplatinum (II) nitrite, Pt(NH₃)₂(NO₂)₂ as a precursor. The substrate was dispersed in the aqueous catalyst precursor solution and the mixture was maintained at 90° C., pH of 3.0 with the diffused passage of carbon monoxide gas through the reaction medium. Hydrazine hydrate was used for the reduction of platinum. Platinum was deposited at 30 -40 wt. % range in order to compare the catalytic activity with some commercial catalysts.

Accelerated Oxidation Test

Oxidation testing was conducted through accelerated thermal sintering experiments on a Micromeritics 2910 Automated Catalyst Characterization System that was modified to allow external gas inputs (H₂O, O₂, and He) through the vapor accessory valve. Fresh 60 mg carbon-based substrates were loaded into 2910 analysis tubes and sintered for 30 hours. These tests were carried out at 250° C. in humidified He gas streams under an 02 concentration of 0.7%. The total gas flow during each sintering test was held constant at 50 sccm. The initial and final sample weight was recorded to determine the percent weight loss.

Electrochemical characterization

The above catalysts, made with platinum supported on anatase or rutile titanium oxide coated carbon blacks, were further tested for their oxygen reduction reaction (ORR) activity. The catalyst sample was prepared for electrochemical measurement by mixing and sonication in a suspension to form an ink for application onto a rotating disk electrode (RDE). The dispersion contained the catalyst particles and a 5% solution of Nafion ionomer in water, all well-dispersed in isopropanol and water.

The supported platinum and carbon containing mixture was put into a sealed 60 ml glass bottle. The content was subsequently mixed by shaking and then sonicated for 2-4 hours. Once a homogeneous ink suspension was formed, 10-20 micro liters of the suspension were dispensed on a glassy carbon electrode surface. After drying at room temperature, the electrode was put on the Rotating Disk Electrode (RDE) device for activity measurement (in μA/cm² of platinum at 0.9V).

A commercial sample of platinum on Vulcan XC-72 was obtained for comparison testing. The platinum on Vulcan XC-72 was applied as in ink to a RDE for comparative electrode activity measurement by the technique described above.

In the electrode activity tests the electrode was rotated at 1,600 RPM in a 0. 1M HClO₄ electrolyte at 60° C. with a flowing, saturated oxygen atmosphere at one atmosphere. The electrode voltage scan rate was 5mV/s over a voltage range of 0 -1V.

### RESULTS AND DISCUSSION

XRD Patterns

XRD patterns were obtained of the A and B samples prepared as described above by ultrasonic irradiation under room temperature conditions. Sample A was found to consist of anatase TiO₂ deposited on the Vulcan Carbon, anataseTiO₂/VC. Sample B was found to consist of rutile TiO₂/VC. In the XRD pattern for sample A, peaks at two-theta angles of 25.3, 37.8, 48.0, 53.8, 54.9 and 62.5 were indexed to the diffractions of (1 0 1), (0 0 4), (2 0 0), (1 0 5), (2 1 1) and (2 0 4) planes of anatase, indicating the developed TiO₂ existing in the anatase state. In the pattern for Sample B, peaks were found at two-theta angles of 27.4, 36.1, 41.2 and 54.3 which were assigned to the diffraction peaks of (1 1 0), (1 0 1), (1 1 1) and (2 1 1) planes of rutile. A close examination of the PXRD patterns showed an interesting phenomenon. The reflections assigned to anatase were always broader than those for rutile, which indicated that anatase is formed in smaller particle sizes as compared with the rutile particles. In fact, according to the Scherrer formula, the particle size of rutile sample is almost twice that of the anatase sample (Table 1).

Porosity and Surface Area

N₂ adsorption isotherms of samples A (anatase TiO₂) and B (rutile TiO₂) were prepared. The isotherms were characteristic of types H2 (for sample A anatase) and H3 (for sample B rutile) [38]. Many porous absorbents tend to give a type H2 loop. However, unlike the mesoporous sample A (anatase) the results obtained for sample B (rutile) indicate its non-mesoporous nature. The pores in sample A may be constructed through the aggregation of particles. In Table 1, the results from BET surface area measurements for the anatase TiO₂/C as well as rutile TiO₂/C are given. These surface measurements (SBET) represent the contributions of both the carbon and titanium dioxide particle surfaces.

TEM and SEM Image

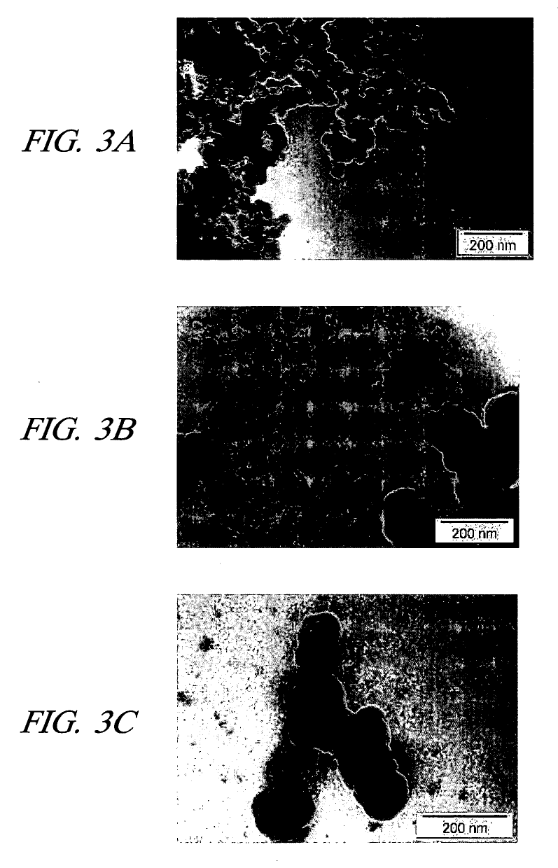

FIG. 3A is a TEM image of a commercial blank Vulcan XC carbon. The nominal average particle size of these carbon particles was about 50 nanometers.

FIG. 3B is a TEM of the anatase TiO₂/C sample and FIG. 3C is a TEM of the rutile TiO₂/C sample. The average particle sizes of anatase TiO₂/C as well as rutile TiO₂/C, as determined from the TEM images, are consistent with those calculated from the XRD peak broadening.

SEM photographs (not shown) were also obtained of anatase and rutile TiO₂ coated on the Vulcan Carbon samples. It was observed that the carbon particles were indeed covered with TiO₂ nanoparticles as determined by EDX microanalysis. Both anatase and rutile TiO₂ nanoparticles were uniformly dispersed onto carbon.

Resistivity

Table 2 compares the resistivity of Vulcan XC-72 carbon particles with and without a titania coating. Since the resistivity measurements were conducted on powder based materials, these numbers are directly related to the packing density. The electrical resistivities measured for all TiO₂ coated carbon materials increase by two magnitudes at higher packing density compared to untreated material. The increased packing density is mainly due to the 30 - 40 wt. % TiO₂ which is denser than that of Vulcan XC-72. These results suggest that if a TiO₂ coating can provide an oxygen corrosion protection layer, it will increase the resistance of the catalyst substrate, since TiO₂ is only a semiconductor material. However, based on extrapolation of the measurement results, the loading of well-dispersed Pt catalyst onto these substrates should improve the conductivity of the catalyst layer since Pt is electrically conductive. Moreover, when titania is appropriately doped, with, for instance Nb, it is far more conductive than non-doped titania. The doping of Nb into the TiO₂ lattice will add electrons into the highest non-occupied orbitals of TiO₂ effectively reducing the band gap and improve the electrical conductivity. Accordingly, doped TiO₂ is expected to have a much higher overall electrical conductivity.

TABLE 2
Electrical Resistivity of Titania Coated Carbon Black

| | Resistivity | Bulk Density |
|---|---|---|
| Samples | (ohm-cm) | (g/cm³) |
| Vulcan | 0.05 | 0.93 |
| Vulcan-Anatase TiO₂ | 7.58 | 1.49 |
| Vulcan-Rutile TiO₂ | 8.05 | 1.75 |

Oxidation

Table 3 compares the oxidation rate of Vulcan XC-72 carbon with and without a titania coating. The mass loss of two catalyst samples were measured after 30 hours of accelerated gas-phase thermal aging and compared with their original mass. The mass loss of an electrocatalyst supported on pure Vulcan XC-72 carbon was 43.5%, while the mass loss of the catalyst supported on rutile and anatase TiO₂ coated Vulcan XC-72 was reduced to 12.4% and 8.1% respectively. These results suggest that a coating of TiO₂ on carbon substrates can indeed provide a corrosion protection layer that will slow down the catalyst degradation in a fuel cell environment.

TABLE 3
Comparison of Oxidation Rate of Titania Coated Carbon Black

| | Mass | |
|---|---|---|
| Samples | Loss After Aging | Explanation |
| Vulcan | −43.5% | Mass loss due to CO₂ |
| | | evolution |
| Vulcan-Anatase TiO₂ | −8.1% | Less mass loss due to the |
| | | corrosion protection |
| | | layer formed on surface |
| | | of carbon |
| Vulcan-Rutile TiO₂ | −12.4% | Less mass loss due to the |
| | | corrosion protection |
| | | layer formed on surface |
| | | of carbon |

HAD Area and ORR Activities

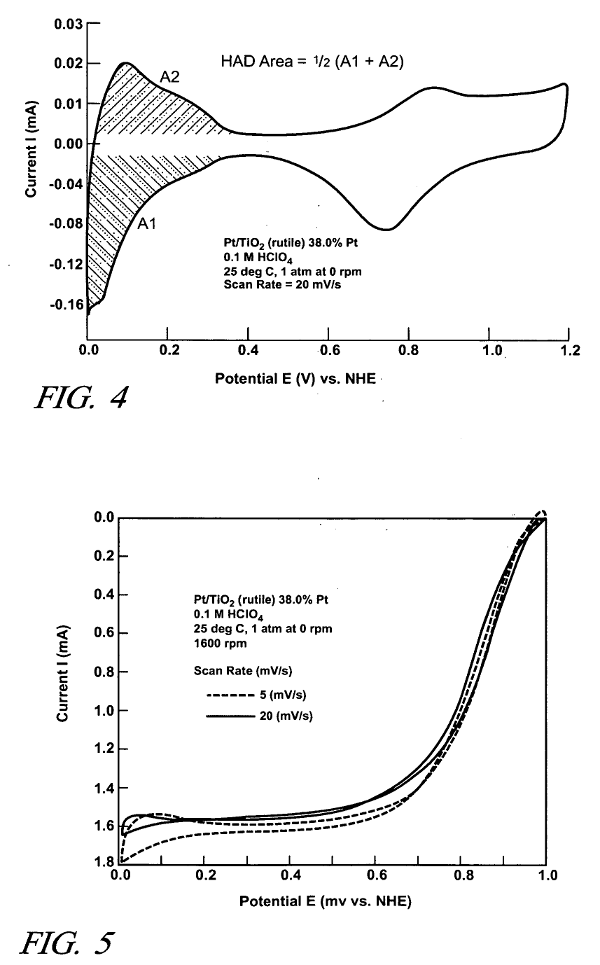

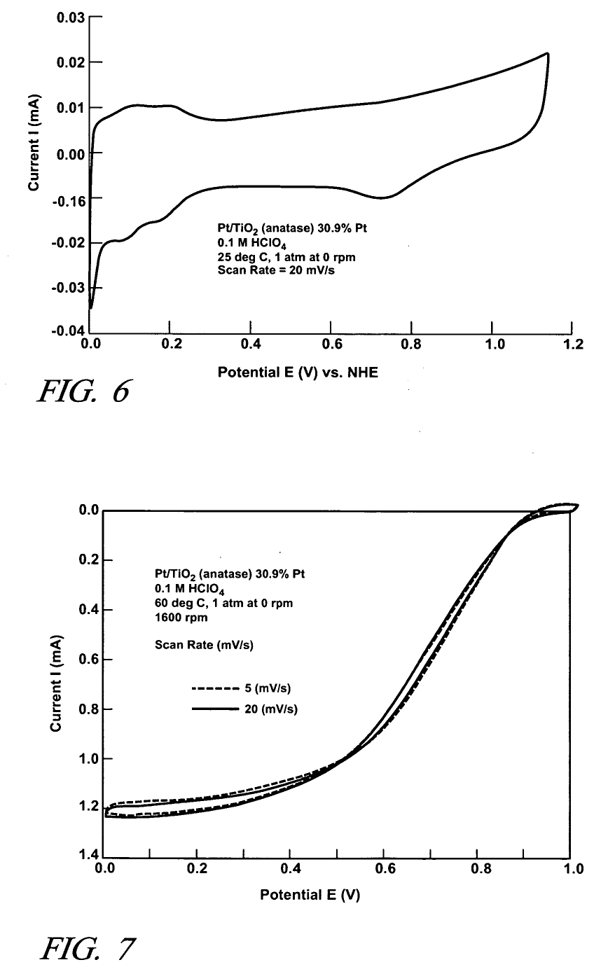

Platinum (Pt) supported on rutile and anatase phase titanium oxide coated on carbon, with Pt loading of 38 wt. % and 30.9 wt. % respectively, were evaluated for their HAD area, ORR mass and specific activities using the rotating disk electrode (RDE) technique. Cyclic voltammetry testing was used to measure the hydrogen absorption area (HAD) and oxygen reduction reactivity (ORR) of the respective materials. HAD area was determined by taking the average areas of the adsorption peak (A1) and desorption peak (A2) as illustrated in FIG. 4 (Pt/TiO₂ rutile). The catalyst loading on the RDE electrode was from 0.02 - 0.07 mg Pt / cm². FIGS. 4 and 6 present the graphical data that provided the determination of the HAD area for the rutile phase-containing and anatase phase-containing carbon supported platinum catalysts. The HAD data is summarized in Table 4. FIGS. 5 and 7 present the graphical data that provided the determination of oxygen reduction reactivity (ORR) of the two materials and the resultant ORR data is summarized in Table 4.

The HAD area and oxygen reduction results, FIGS. 4-7, present an interesting contrast. Rutile TiO₂ coated carbon behaved unremarkably, displaying an oxidation behavior typical of platinized carbon. By contrast, anatase coated carbon showed a small activity. Table 4 compares the HAD area and ORR activities of samples A and B with one of the best commercial catalysts supported on Vulcan carbon only. Reproducible HAD areas were obtained before and after the ORR activity measurement under the standard measurement conditions (25° C., 1 atmosphere, 0 RPM, scan rate of 20 mV/s in saturated argon (Ar), voltage range of 0-1.2V) for both catalyst prepared with rutile and anatase phase TiO₂ coated carbons.

TABLE 4
Comparison of HAD and ORR Activity of
Titania Coated Carbon Blacks

| | | ORR Activity at |
|---|---|---|
| | HAD | 0.9 V |
| Samples | (m²/g) | (mA/cm²) |
| Pt/Vulcan Carbon | 60 | 170 |
| Pt/Vulcan-Rutile | 25 | 225 |
| TiO₂ | | |
| Pt/Vulcan- | 13 | 27 |
| Anatase TiO₂ | | |

Since the two catalyst samples were prepared and pretreated under same conditions, it is obvious that Pt/Vulcan-TiO₂ rutile is a more effective electrocatalyst for the oxygen reduction activity. However, both rutile and anatase are electrical insulators and it would be expected that there would be minimal electrochemical activity on both. Subsequently, it is reasonable to attribute the observed behavior to differences in the extent of coverage on carbon. In the XRD data and in the SEM images, FIGS. 3A-3C, rutile was seen to form comparatively large particles on carbon while anatase appears to be present as smaller particles.

The origins of these differences are most likely due to the behavior of the different precursors. TPT contains propyl groups. If hydrolysis during the sol formation is incomplete, the titanium species containing those groups are likely to absorb onto the surface of activated carbon. Subsequent ultrasonically assisted formation of the oxide, would be more likely to result in coating of the carbon due to a seeding effect. The sol formed from the TTC does not contain any organic residues and will therefore have no particular tendency to absorb onto the surface of carbon. It should be essentially a hydroxide. Oxide clusters will form and grow in solution and be deposited onto the carbon after they form. Incomplete coverage would be expected and Pt should deposit on carbon and rutile.

Further evidence for more complete anatase coverage can be seen in Table 3. Less surface area of carbon is available for oxidation, subsequently the oxidation proceeds more slowly. The lower electrical resistivity (Table 2) exhibited by the anatase coated material would, at first glance, contradict this conclusion. However, the difference is most likely due to a thinner coating of titania, which is implied by the density measurements.

The practice of the invention has been illustrated by the formation of titanium dioxide coatings on carbon particles. But useful oxidation resistant PEM catalyzed electrodes can be prepared using other suitable metal oxide or phosphate containing coatings on carbon surfaces. The scope of the invention is not to be limited by the illustration of preferred embodiments.

1. A fuel cell electrode comprising:
carbon particles carrying a coating of smaller particles of a metal oxide and/or a metal phosphate as a supporting material for particles of a catalyst, the coating of smaller particles being formed to impede oxidation of the carbon particles while permitting conduction of electrons between the carbon particles, and
particles of a catalyst on the supporting material of carbon particles and smaller coating particles.

2. A fuel cell electrode as recited in claim 1 in which the coating of smaller particles comprises one or more oxides of one or more metals selected from the group consisting of chromium, cobalt, copper, indium, iron, molybdenum, nickel, tin, titanium, tungsten, vanadium, and zirconium.

3. A fuel cell electrode as recited in claim 1 in which the coating of smaller particles comprises titanium dioxide.

4. A fuel cell electrode as recited in claim 1 in which the coating of smaller particles comprises rutile titanium dioxide.

5. A fuel cell electrode as recited in claim 1 in which smaller coating particles are doped with an additive for increasing electrical conductivity.

6. A fuel cell electrode as recited in claim 1 in which the coating of smaller particles comprises titanium dioxide doped with niobium or triphenyl amine.

7. A fuel cell electrode as recited in claim 1 in which the particles of catalyst comprise platinum.

8. A fuel cell comprising:
a polymer electrolyte membrane having an anode and an oxygen-reducing cathode;
the oxygen reducing cathode comprising carbon particles carrying a coating of smaller particles of a metal oxide as a supporting material for particles of a catalyst, the coating of smaller particles being formed to impede oxidation of the carbon particles while permitting conduction of electrons between the carbon particles, and
particles of a catalyst on the supporting material of carbon particles and smaller coating particles.

9. A fuel cell as recited in claim 8 in which the smaller coating particles comprise one or more oxides of one or more metals selected from the group consisting of chromium, cobalt, copper, indium, iron, molybdenum, nickel, titanium, tungsten, vanadium, and zirconium.

10. A fuel cell as recited in claim 8 in which the carbon particles are coated with smaller particles of titanium dioxide.

11. A fuel cell as recited in claim 8 in which the carbon particles have a specific surface area of about 100 square meters per gram before being coated with smaller metal oxide particles.

12. A fuel cell as recited in claim 8 in which the metal oxide coating particles are doped with an additive for increasing electrical conductivity.

13. A fuel cell as recited in claim 8 in which the carbon particles are coated with smaller particles of titanium dioxide and the particles of titanium dioxide are doped with an additive for increasing electrical conductivity.

14. A fuel cell as recited in calm 8 in which the particles of catalyst comprise platinum.

15. A method of making an oxygen reducing electrode for a fuel cell comprising a polymer electrolyte membrane, an anode and an oxygen reducing cathode, the method comprising:
dispersing carbon particles in a liquid medium;
dispersing a precursor compound of a metal oxide or metal phosphate in the liquid medium;
subjecting the liquid medium to ultrasonic vibrations to decompose the precursor compound and deposit the metal oxide or phosphate as a coating of metal oxide or phosphate particles on the carbon particles; and, subsequently
depositing particles of a catalyst on metal oxide or phosphate particle coated carbon particles.

16. A method as recited in claim 15 in which the liquid medium is water and the precursor compound is a metal alkoxide.

17. A method as recited in claim 15 in which the liquid medium is water and the precursor compound is a metal halide.

18. A method as recited in claim 15 in which the liquid medium is water and the precursor compound is a titanium alkoxide.

19. A method as recited in claim 15 in which the liquid medium is water and the precursor compound is a titanium halide.

20. A method as recited in claim 15 in which the particles of catalyst comprise platinum.
